(19) United States
(12) Patent Application Publication
(10) Pub. No.: US 2014/0201275 A1
(43) Pub. Date: Jul. 17, 2014

(54) SYSTEM AND METHOD FOR MANAGING A CONVERSATION FOR A MEETING SESSION IN A NETWORK ENVIRONMENT

(71) Applicants: Haihua Huang, Suzhou (CN); Yong Qian, Suzhou (CN); Yaqing Zhang, Suzhou (CN); Kejun Xia, Suzhou (CN)

(72) Inventors: Haihua Huang, Suzhou (CN); Yong Qian, Suzhou (CN); Yaqing Zhang, Suzhou (CN); Kejun Xia, Suzhou (CN)

(73) Assignee: CISCO TECHNOLOGY, INC., San Jose, CA (US)

(21) Appl. No.: 13/742,943

(22) Filed: Jan. 16, 2013

(51) Int. Cl. H04L 29/06

(52) U.S. Cl. CPC H04L 65/403
USPC 709/204

(57) ABSTRACT

An example method is provided and includes receiving conversation precondition information associated with a meeting session in a network environment, determining, after a beginning of the meeting session, conversation precondition status information of at least one collaboration criteria indicated by the conversation precondition information, and causing a meeting client program to provide a representation of the conversation precondition status information.

### TECHNICAL FIELD

This disclosure relates in general to the field of communications and, more particularly, to managing conversations for a meeting session in a network environment.

### BACKGROUND

In certain architectures, service providers and/or enterprises may seek to offer sophisticated online conferencing services for their end users. The conferencing architecture may offer an “in-person” meeting experience over a network. Conferencing architectures may also deliver real-time interactions between people using advanced visual, audio, and multimedia technologies. Virtual meetings and conferences have an appeal because they may be held without the associated travel inconveniences and costs. In addition, virtual meetings may provide a sense of community to participants who are dispersed geographically. There are new interactive paradigms that have emerged that differ from face-to-face interactions.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified schematic diagram of a communication system for managing a conversation in accordance with at least one example embodiment;

FIGS. 2A-2C are timing diagrams indicating timing associated with communication according to at least one example embodiment;

FIGS. 3A-3B are illustrations showing example user interface representations associated with a meeting client program according to at least one example embodiment;

FIG. 4 is a flow diagram illustrating activities associated with managing a conversation according to at least one example embodiment;

FIG. 5 is another flow diagram illustrating activities associated with managing a conversation according to at least one example embodiment;

FIG. 6 is still another flow diagram illustrating activities associated with managing a conversation according to at least one example embodiment;

FIG. 7 is yet another flow diagram illustrating activities associated with managing a conversation according to at least one example embodiment;

FIG. 8 is yet still another flow diagram illustrating activities associated with managing a conversation according to at least one example embodiment; and

FIG. 9 is a simplified schematic diagram illustrating possible details related to an example infrastructure of a communication system in accordance with at least one example embodiment.

### DETAILED DESCRIPTION OF EXAMPLE EMBODIMENTS

### Overview

An example method is provided that includes receiving conversation precondition information associated with a meeting session in a network environment; determining, after a beginning of the meeting session, conversation precondition status information of at least one collaboration criteria indicated by the conversation precondition information; and causing a meeting client program to provide a representation of the conversation precondition status information.

### Example Embodiments

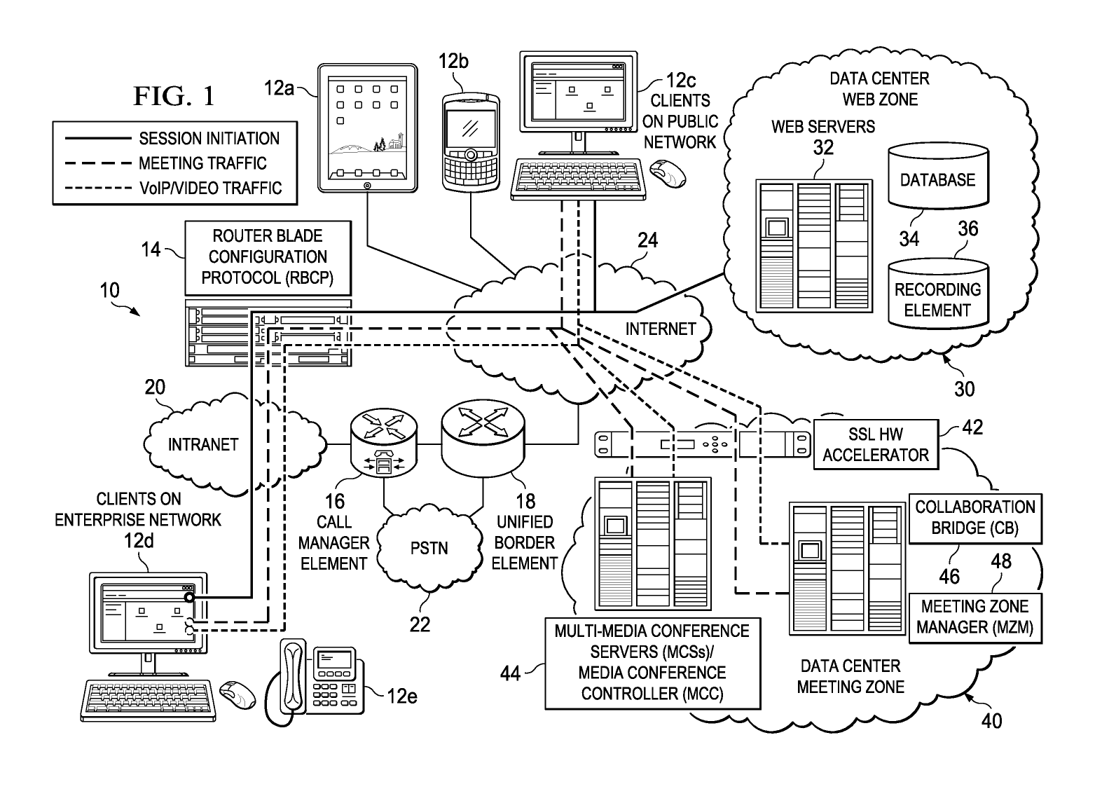

FIG. 1 is a simplified schematic diagram of a communication system 10 for managing a conversation in accordance with at least one example embodiment. Communication system 10 may include a number of endpoints 12a-e that may achieve suitable network connectivity via various points of attachment. In the example of FIG. 1, communication system 10 includes an Intranet 20, a public switched telephone network (PSTN) 22, and an Internet 24, which (in this particular example) offers a pathway to a data center web zone 30 and a data center meeting zone 40.

Data center web zone 30 includes a plurality of web servers 32, a database 34, and a recording element 36. Data center meeting zone 40 includes a secure sockets layer hardware (SSL HW) accelerator 42, a plurality of multimedia conference servers (MCSs)/media conference controller (MCC) 44, a collaboration bridge 46, and a meeting zone manager 48. In at least one example embodiment, each MCS may be configured to coordinate video and voice traffic for a given online meeting. Additionally, each MCC may be configured to manage the MCS from data center meeting zone 40.

Various types of routers and switches may be used to facilitate communications amongst any of the elements of FIG. 1. For example, a call manager element 16 and a unified border element 18 may be provisioned between PSTN 22 and Intranet 20. Also depicted in FIG. 1 are a number of pathways (e.g., shown as solid or broken lines) between the elements for propagating meeting traffic, session initiation, and voice over Internet protocol (VoIP)/video traffic.

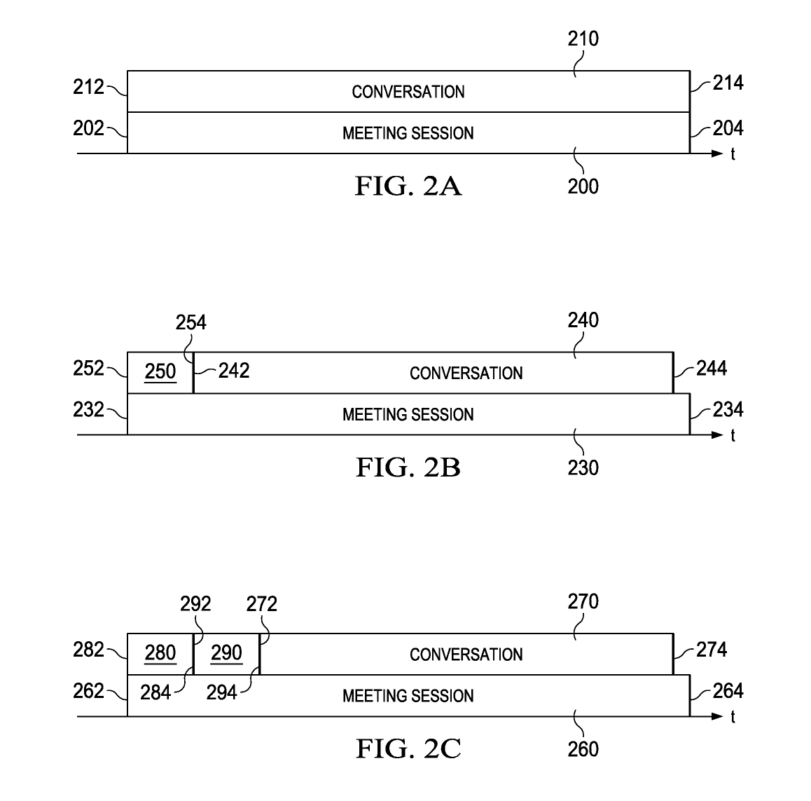

FIGS. 2A-2C are timing diagrams indicating timing associated with communication according to at least one example embodiment. The examples of FIGS. 2A-2C are merely example of timing relationships and do not limit the claims in any way. FIG. 2A is a timing diagram indicating timing associated with communication according to at least one example embodiment. The example of FIG. 2A shows a conversation time period 210 in relation to a meeting session time period 200. Conversation time period 210 has a beginning time 212 and an ending time 214. Meeting session time period 200 has a beginning time of 202 and an end time of 204. In at least one example embodiment, conversation is the communication between meeting participants regarding the subject matter of the meeting. For example, if a meeting is covering project planning, the conversation is the communication that relates to project planning. In the example of FIG. 2A, conversation beginning time 212 corresponds with meeting session beginning time 202 and conversation ending time 214 corresponds with meeting session ending time 204. Such circumstances indicate that at the time that the meeting session begins, the participants begin communication regarding the subject matter of the meeting.

However, under many circumstances, conversation does not begin at the same time as the meeting session. Many meetings that take place with distributed participants involve circumstances where participants join the meeting at various times before the meeting session begins and/or after the meeting session begins. A participant is considered to have joined a meeting session by establishing a connection from an endpoint, such as endpoint 12a, for the purpose of attending the meeting. For example, the attendee may join the meeting session before the meeting session begins by way of joining the meeting session before commencement of VOIP traffic, video traffic, and/or the like. In another example, the attendee may join the meeting session after the meeting session begins by way of joining the meeting session after commencement of VOIP traffic, video traffic, and/or the like.

In some circumstances, it may be desirable to defer conversation in the meeting until certain collaboration objectives are satisfied. A collaboration objective relates to a set of collaboration criteria that is desired to be satisfied before the beginning of conversation. For example, a collaboration objective may relate to satisfying quorum requirements, ensuring that missing meeting invitees are given ample time to join the meeting session before conversation begins, ensuring that key invitees are present in the meeting session during the conversation, etc. An invitee relates to a person who was invited to join the meeting session. A collaboration objective may comprise one or more collaboration criteria. For example, a collaboration objective may comprise a collaboration criteria that a set of one or more invitees join the meeting session before conversation begins, that a certain amount of time elapses before conversation begins, that a percentage of invitees join the meeting session before conversation begins, that a specified number of invitees join the meeting session before conversation begins, and/or the like.

In some circumstances, the collaboration objective may relate to a combination of collaboration criteria with various correlations with the satisfaction of the collaboration objective. For example, a collaboration objective may relate to giving key invitees a specified amount of time to join the meeting session before conversation begins. Such a collaboration objective may be satisfied by a collaboration criteria of the list of key invitees being satisfied or the time collaboration criteria being satisfied. In another example, a collaboration objective may relate to ensuring that key invitees join the meeting session and that other invitees are given a specified time to join the meeting session late before the conversation begins. Such a collaboration objective may be satisfied by a collaboration criteria of the list of key invitees being satisfied and the time collaboration criteria being satisfied. These collaboration objectives may be referred to as conversation preconditions.

In some circumstances, there may be some participants that are aware of the conversation preconditions and other participants that are unaware of the conversation preconditions. In such circumstances, there may be confusion and delay associated with communicating, for example verbally, conversation preconditions to participants as the participants join the meeting session. For example, some participants may join the meeting session during communication of conversation preconditions, after communication of conversation preconditions, and/or the like. Under such circumstances, communication of conversation preconditions may need to be repeated, participants may become confused or annoyed, and/or the like. It may be desirable to allow participants to understand the conversation preconditions without such confusion and annoyance.

In some circumstances, even if the participants are aware of the conversation preconditions, there may be some participants that are aware of the status of the conversation preconditions and other participants that are unaware of the status of the conversation preconditions. The status of conversation preconditions relates to the status of one or more collaboration criteria, the status of a collaboration objective, and/or the like. For example, status of a key invitee collaboration criteria may relate to which key invitees have joined the meeting session, which key invitees have not joined the meetings session, and/or the like. In another example, status of a time collaboration criteria may relate to how much time has elapsed in relation to the collaboration criteria, how much time remains before the time collaboration criteria is satisfied, and/or the like.

In still another example, status of an attendance collaboration criteria may relate to a percentage of invites who have joined the meeting session, a percentage of invitees who remain to join the meeting session to satisfy the collaboration criteria, a number of attendees that have joined the meeting session, a number of attendees who remain to join the meeting session to satisfy the collaboration criteria, and/or the like. In such circumstances, there may be confusion and delay associated with attendees becoming aware of the status of the conversation preconditions. For example, some attendees may independently monitor conversation preconditions to varying degrees of precision or accuracy. Additionally, some participants may be unaware of status of the conversation preconditions, other participants may be aware of less than all of the status of the conversation preconditions, while still other participants may be aware of all of the status of the conversation preconditions. Under such circumstances, communication of conversation precondition status may need to be repeated, participants may become confused or annoyed, there may be communication of conflicting information regarding conversation precondition status, and/or the like. As a result, some participants may be distracted, may attend to other business without any notion of when to return attention to the meeting session, etc.

It may be desirable to allow participants to understand the status of conversation preconditions without such confusion and annoyance. In at least one example embodiment, a collaboration criteria is satisfied when the conditions indicated by the collaboration criteria become true. For example, if a collaboration criteria is that at least 80% of invitees join the meeting session, the collaboration criteria is satisfied when at least 80% of the invitees join the meeting session. In at least one example embodiment, a collaboration objective is satisfied when the criteria of the collaboration criteria become true in accordance with their relationship to the collaboration objective. For example, if the collaboration objective relates to a first collaboration criteria or a second collaboration criteria, the collaboration objective is satisfied when at least one of the collaboration criteria is satisfied. In another example, if the collaboration objective relates to a first collaboration criteria and a second collaboration criteria, the collaboration objective is satisfied when both of the collaboration criteria is satisfied.

In at least one example embodiment, a participant may be made aware of conversation preconditions by way of the endpoint that the participant is using, for example, by way of a meeting client program that is used by the endpoint to interact with the participant regarding the meeting session. In at least one example embodiment, a conversation precondition may be indicated by conversation precondition information. Conversation precondition information may relate to data, a data structure, and event, a message, and/or the like, that provides information that communicates a conversation precondition. In at least one example embodiment, a conversation precondition status may be indicated by conversation precondition status information. Conversation precondition status information may relate to data, a data structure, and event, a message, and/or the like, that provides information that communicates a conversation precondition status. In at least one example embodiment, the meeting client program may provide the participant with a representation of the conversation precondition information, a representation of conversation precondition status information, a representation indicating that a collaboration objective has been satisfied, a representation indicating that at least one collaboration criteria has been satisfied, and/or the like.

In at least one example embodiment, a meeting session participant, such as a meeting host, may provide conversation precondition information to be associated with the meeting session. The meeting participant may provide the conversation precondition information when establishing the meeting session, such as when selecting invitees, when modifying meeting session parameters before the beginning of the meeting session, such as when modifying invitees or meeting session date, during the meeting session, and/or the like. For example, a host may cause the conversation precondition information to be stored in data center web zone 30 prior to a meeting session. In another example, a participant may send conversation precondition information by way of the meeting client program during the meeting session.

To generate the conversation precondition information, there may be a list of collaboration criteria categories to select. A collaboration criteria category relates to the type of information that is evaluated to determine whether a collaboration criteria is satisfied. For example, a collaboration criteria category may relate to determining collaboration criteria satisfaction based on a list of one or more invitees joining the meeting. In another example, a collaboration criteria category may relate to an amount of time that elapses. In another example, a collaboration criteria category may relate to a percentage of invitees joining. In still another example, a collaboration criteria category may relate to a number of invitees joining the meeting.

To further generate the conversation precondition information, there may be one or more parameters to associate with a selected collaboration criteria category that was selected. The parameter relates to at least one datum upon which to evaluate the collaboration criteria category that was selected. For example, the parameter may be a time period value, a list of one or more invitees, a value for minimum number of participants, a value for minimum percentage of participants, and/or the like. Therefore, the collaboration criteria may relate to a collaboration criteria category and one or more parameters associated with the collaboration criteria category. The collaboration criteria may be indicated by collaboration criteria information, which may be data, one or more data structures, and/or the like.

In addition, to further generate the conversation precondition information, interrelationship between more than one collaboration criteria may be provided. For example, an “or” relationship may be selected between collaboration criteria, an “and” relationship may be selected between collaboration criteria, a combination of “and” and “or” relationships may be selected among collaboration criteria, and/or the like.

FIG. 2B is a timing diagram indicating timing associated with communication according to at least one example embodiment. The example of FIG. 2B shows a conversation time period 240 in relation to a meeting session time period 230 and a non-conversation time period 250. Conversation time period 240 has a beginning time 242 and an ending time 244. Meeting session time period 230 has a beginning time of 232 and an end time of 234. Non-conversation time period 250 has a beginning time 252 and an ending time 254. In the example of FIG. 2B, non-conversation beginning time 252 corresponds with meeting session beginning time 232 and non-conversation ending time 254 corresponds with conversation beginning time 242. Such circumstances indicate that at the exact time that the meeting session begins, the participants have not begun communication regarding the subject matter of the meeting, but instead begin communication regarding the subject matter of the meeting after non-communication time period 250. Non-communication time period may relate to a time period in which at least one meeting participant is waiting for satisfaction of a conversation precondition. In at least one example embodiment, non-conversation ending time 254 relates to a time at which the conversation precondition is satisfied.

In at least one example embodiment, during non-conversation time period 250, the meeting client program provides the participant with a representation of the conversation precondition information, a representation of conversation precondition status information, a representation indicating that a collaboration objective has been satisfied, and/or the like. In at least one example embodiment, at the non-conversation ending time 254, the meeting client program provides the participant with a representation indicating that a collaboration objective has been satisfied, a representation indicating that at least one collaboration criteria has been satisfied, and/or the like.

It can be seen that conversation ending time 244 is before meeting session ending time 234. This relationship between ending times relates to the communication regarding the subject matter of the meeting ending before the meeting session ends. For example, the communication regarding the subject matter of the meeting may end during the meeting session, and the participants may begin leaving the meeting session for a period of time before the meeting session ends.

FIG. 2C is a timing diagram indicating timing associated with communication according to at least one example embodiment.

The example of FIG. 2C shows a conversation time period 270 in relation to a meeting session time period 260, a first non-conversation time period 280, and a second non-conversation time period 290. Conversation time period 270 has a beginning time 272 and an ending time 274. Meeting session time period 260 has a beginning time of 262 and an end time of 264. The first non-conversation time period 280 has a beginning time 282 and an ending time 284. The second non-conversation time period 290 has a beginning time 292 and an ending time 294. In the example of FIG. 2C, first non-conversation beginning time 282 corresponds with meeting session beginning time 262, first non-conversation ending time 284 corresponds with second non-conversation beginning time 292, and second non-conversation ending time 294 corresponds with conversation beginning time 272. Such circumstances indicate that at the exact time that the meeting session begins, the participants have not begun communication regarding the subject matter of the meeting, but instead begin communication regarding the subject matter of the meeting after second non-communication time period 290. In at least one example embodiment, second non-conversation ending time 294 relates to a time at which the conversation precondition is satisfied.

In at least one example embodiment, first non-conversation time period 280 relates to a time period in which a participant is not made aware of any conversation precondition information, and second non-conversation time period 290 relates to a time period in which a participant is made aware of conversation precondition information. For example, during first non-conversation time period 280, the meeting client program may omit any representation of any conversation precondition information. In such an example, at second non-communication beginning time 292, the meeting client program may begin providing the participant with a representation of the conversation precondition information, a representation of conversation precondition status information, a representation indicating that a collaboration objective has been satisfied, and/or the like. In such an example embodiment, at the non-conversation ending time 294, the meeting client program may provide the participant with a representation indicating that a collaboration objective has been satisfied, a representation indicating that at least one collaboration criteria has been satisfied, and/or the like. In such an embodiment, a meeting host may provide conversation precondition information during non-conversation time period 280, which becomes represented at second non-conversation beginning time 292.

In at least one example embodiment, there may be a change in conversation precondition information during a meeting session. For example, in such an embodiment, first non-conversation time period 280 relates to a time period in which a participant is made aware of conversation precondition information, and second non-conversation time period 290 relates to a time period in which a participant is made aware of different conversation precondition information. For example, during first non-conversation time period 280, a participant may change the conversation precondition information to different conversation precondition information. In such an example, at first non-conversation ending time 284, the meeting client program may terminate representation of the conversation precondition information, terminate a representation of conversation precondition status information, terminate a representation indicating that a collaboration objective has been satisfied, and/or the like. In such an example, at second non-communication beginning time 292, the meeting client program may begin providing the participant with a representation of the different conversation precondition information, begin providing a representation of different conversation precondition status information, begin providing a representation indicating that a collaboration objective has been satisfied, and/or the like. In such an example embodiment, at the second non-conversation ending time 294, the meeting client program may provide the participant with a representation indicating that a collaboration objective has been satisfied, a representation indicating that at least one collaboration criteria has been satisfied, and/or the like.

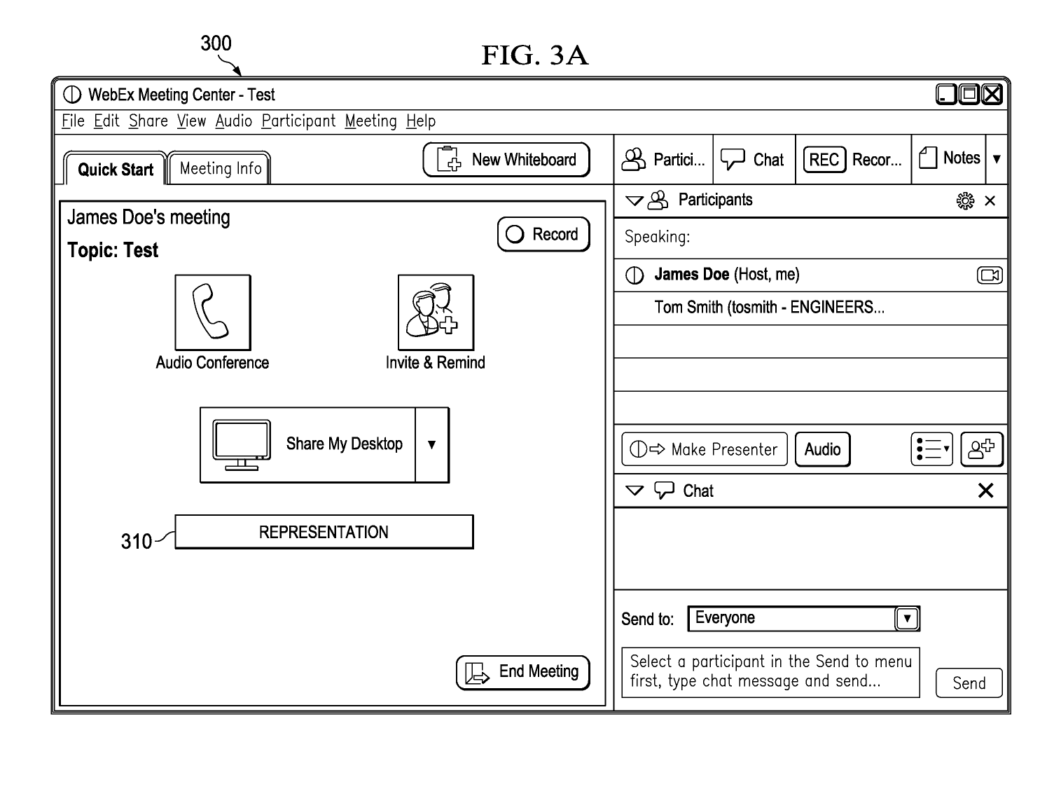

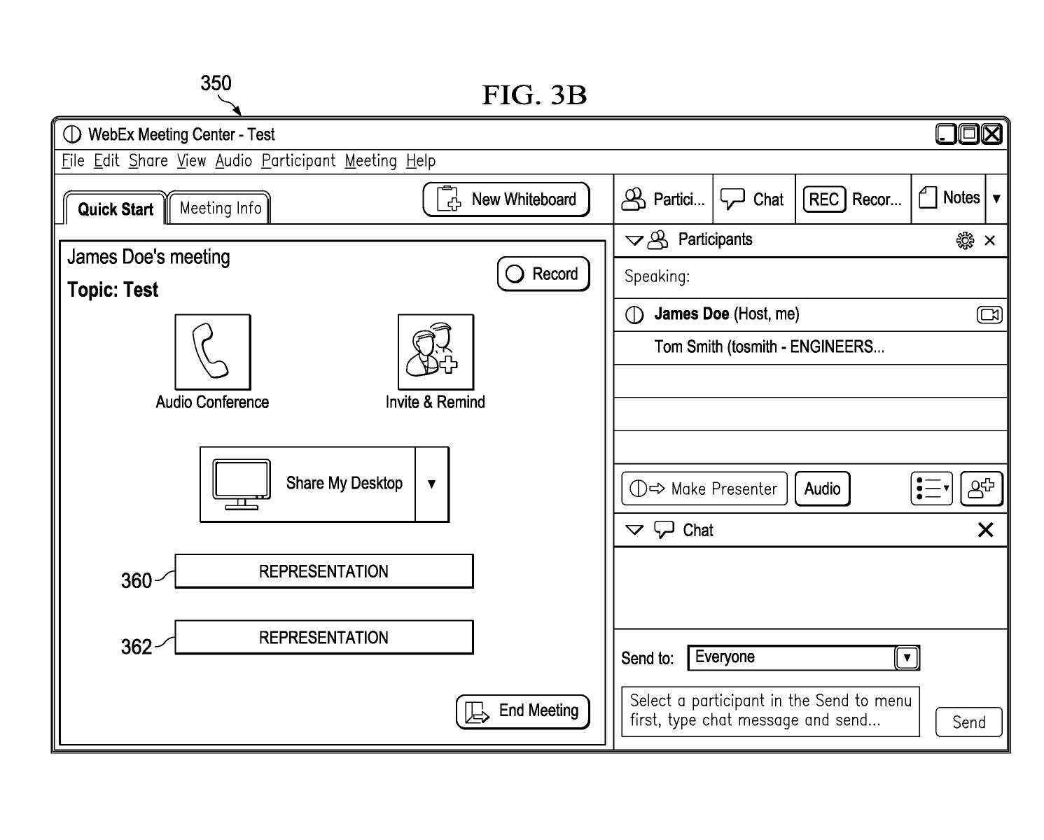

FIGS. 3A-3B are illustrations showing example user interface representations associated with a meeting client program according to at least one example embodiment. The representations of FIGS. 3A-3B are merely examples and do not limit the claims in any way. For example, the representation of the meeting client program may vary, the information represented may vary, the format may vary, position of representations may vary, number of representations associated with conversation precondition information may vary, size of representation associated with conversation precondition information may vary, and/or the like.

In at least one example embodiment, a media client program may provide a representation of conversation precondition information, a representation of conversation precondition status information, a representation that at least one collaboration criteria has been satisfied, a representation that a collaboration objective has been satisfied, and/or the like. Such a representation may relate to causing visual display of information, playing of audio information, providing a tactile signal, and/or the like. For example, visual display of information may be a text representation, a graphical representation, such as an image or a video, and/or the like.

FIG. 3A is an illustration showing example user interface representations associated with a meeting client program according to at least one example embodiment. The example of FIG. 3A shows representation 310 with respect to a meeting client program user interface. In at least one example embodiment, representation 310 comprises a representation of conversation precondition status information. For example, if conversation precondition status information indicates a collaboration criteria to wait for 3 specific invitees, Mo, Larry, and Curley, to join the meeting session, the representation of the conversation precondition status information may be a representation that makes the viewer of the representation aware of, at least part of, the status of the collaboration criteria. For example, the representation may comprise text stating “Curley has attended, still waiting for 2 invitees”, stating “Curley has joined. Waiting for Mo and Larry to join”, “Still waiting for Mo and Larry to attend”, and/or the like. In another example, if conversation precondition status information indicates a conversation precondition that 5 minutes elapse before conversation begins, representation of conversation precondition status information may comprise text stating “3 minutes have elapsed”, text stating “waiting 2 more minutes”, text stating “conversation starts in 2 minutes”, a progress bar indicating time passage, and/or the like. In another example, if conversation precondition status information indicates a conversation precondition to wait for 80% of invitees to join the meeting session, the representation may comprise text stating “20% have attended. Still waiting for 60%”, “20% have attended, still waiting for 72 people”, a progress bar indicating number of participants, and/or the like.

In at least one example embodiment, representation 310 comprises a representation that at least one collaboration criteria indicated by conversation precondition information has been satisfied. This representation may be a change in color of a representation of the status associated with the collaboration criteria, removal of representation of the status associated with the collaboration criteria, a text statement indicating that the collaboration criteria has been satisfied, and/or the like.

In at least one example embodiment, representation 310 comprises a representation that a collaboration objective indicated by conversation precondition information has been satisfied. This representation may be a change in color of a representation of the status associated with the conversation precondition information, removal of representation of the status associated with the conversation precondition information, a text statement indicating that the conversation precondition information has been satisfied, and/or the like.

In at least one example embodiment, provision of representation 310 may be caused by receiving of conversation precondition status information, a notification indicating a change in conversation precondition status information, a notification that a collaboration criteria has been satisfied, a notification that a collaboration objective has been satisfied, and/or the like.

FIG. 3B is an illustration showing example user interface representations associated with a meeting client program according to at least one example embodiment. The example of FIG. 3B shows representation 360 and representation 362 with respect to a meeting client program user interface. In at least one example embodiment, representation 362 comprises a representation of conversation precondition status information similar as described regarding FIG. 3A. In at least one example embodiment, representation 360 comprises a representation of conversation precondition information. For example, if conversation precondition status information indicates a collaboration criteria to wait for 3 specific invitees to join the meeting session, Mo, Larry, and Curley, the representation of the conversation precondition information may be a representation that makes the viewer of the representation aware of, at least part of, the collaboration criteria. For example, the representation may comprise text stating “waiting for 3 invitees”, stating “Waiting for Mo, Larry, and Curley to join”, and/or the like. In another example, if conversation precondition status information indicates a conversation precondition that 5 minutes elapse before conversation begins, representation of conversation precondition information may comprise text stating “waiting 5 minutes to start”, text stating “conversation starts after 5 minutes”, and/or the like. In another example, if conversation precondition status information indicates a conversation precondition to wait for 80% of invitees to join the meeting session, the representation may comprise text stating “waiting for 80% participants to attend”, “need 80% of participants to start”, and/or the like.

In at least one example embodiment, representation 362 is provided before the meeting session begins. In such an embodiment, a participant may benefit by understanding conversation preconditions before the meeting session begins and be allowed to plan accordingly, such as remind key invitees, remind other invitees, ensure the participant's presence at the beginning of the conversation, etc. In at least one example embodiment, provision of representation 310 may be caused by receiving of conversation precondition information, a notification indicating a change in conversation precondition information, and/or the like.

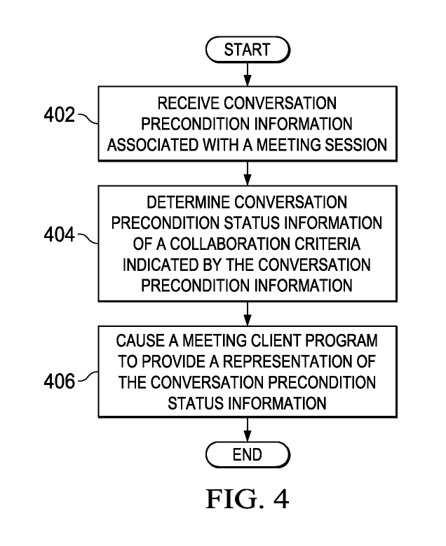

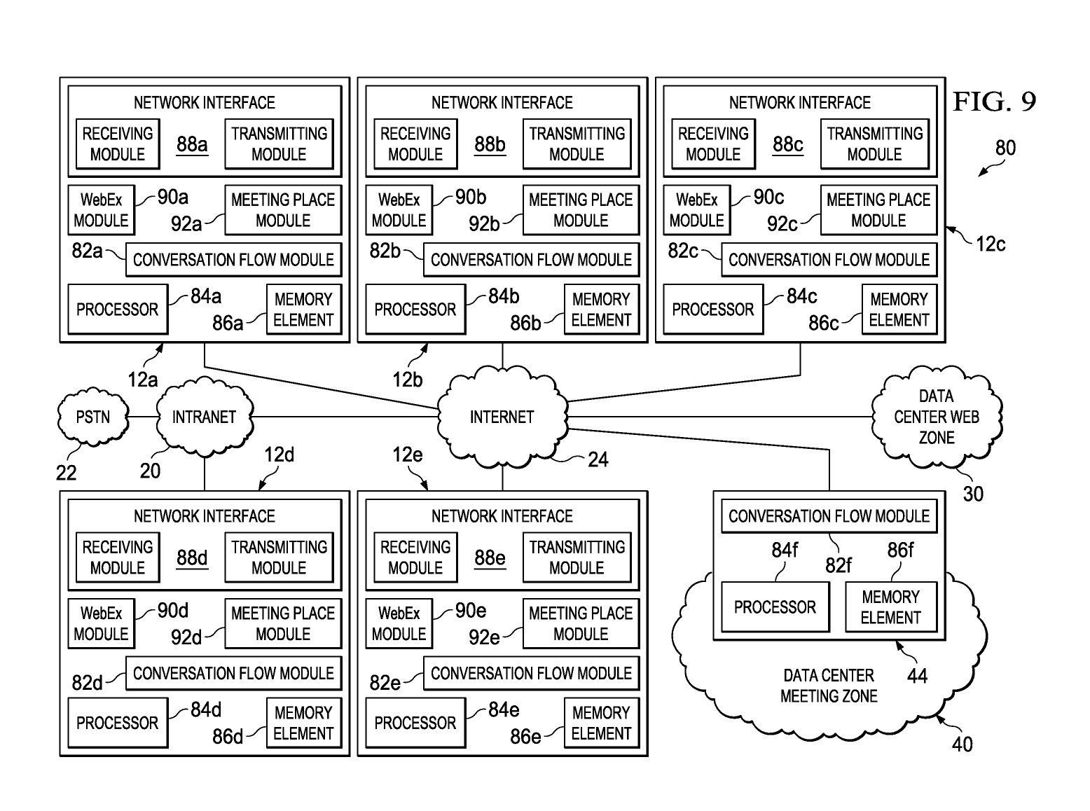

FIG. 4 is a flow diagram illustrating activities associated with managing a conversation according to at least one example embodiment. In at least one example embodiment, there is a set of operations that corresponds the activities of FIG. 4. An apparatus, for example MCS/MCC 44 of FIG. 1 and FIG. 9, or a portion thereof, may utilize the set of operations. The apparatus may comprise means, including, for example processor 84f of FIG. 9, for performing such operations. In an example embodiment, an apparatus, for example MCS/MCC 44 of FIG. 1 and FIG. 9, is transformed by having memory, for example memory element 86f of FIG. 9, comprising computer code configured to, working with a processor, for example processor 84f of FIG. 9, cause the apparatus to perform set of operations of FIG. 4.

At block 402, the apparatus receives conversation precondition information associated with a meeting session. In at least one example embodiment, the conversation precondition information is received from a repository, such as data center web zone 30. In such an embodiment, a meeting session participant may have previously stored conversation precondition information in the repository, for example, when the meeting session was scheduled, at a time between the scheduling of the meeting session and the beginning of the meeting session, when setting default meeting session characteristics, and/or the like. In at least one example embodiment, conversation precondition information may be received by way of a meeting client program similar as described regarding FIGS. 2A-2C. In at least one example embodiment, the conversation precondition information is received before the beginning of the meeting session.

In at least one example embodiment, the conversation precondition information is received after the beginning of the meeting session. In at least one example embodiment, the apparatus causes a meeting client program to provide a representation of the conversation precondition information. In at least one example embodiment, provision of representation 310 is caused by sending of conversation precondition information, a notification indicating a change in conversation precondition information, and/or the like.

At block 404, the apparatus determines conversation precondition status information of at least one collaboration criteria indicated by the conversation precondition information. In at least one example embodiment, the apparatus performs determination after the beginning of the meeting session. The conversation precondition status may be determined by evaluating collaboration criteria, evaluating a collaboration objective, and/or the like. Evaluating a collaboration criteria may comprise determining a collaboration criteria category and determining if the parameters of the collaboration criteria match an attribute of the meeting session. For example, an attribute of the meeting session may comprise an amount of time since the meeting session began, a list of participants who have joined the meeting session, a list of invitees who have not joined the meeting session, and/or the like. The apparatus may generate conversation precondition status information based on evaluation of one or more collaboration criteria against one or more attributes of the meeting session, evaluation of a collaboration objective against one or more attributes of the meeting session, and/or the like.

At block 406, the apparatus causes a meeting client program to provide a representation of the conversation precondition status information. In at least one example embodiment, causing provision of the representation of the conversation precondition status information may be caused by sending of conversation precondition status information, a notification indicating a change in conversation precondition status information, a notification that a collaboration criteria has been satisfied, a notification that a collaboration objective has been satisfied, and/or the like, to a meeting client program.

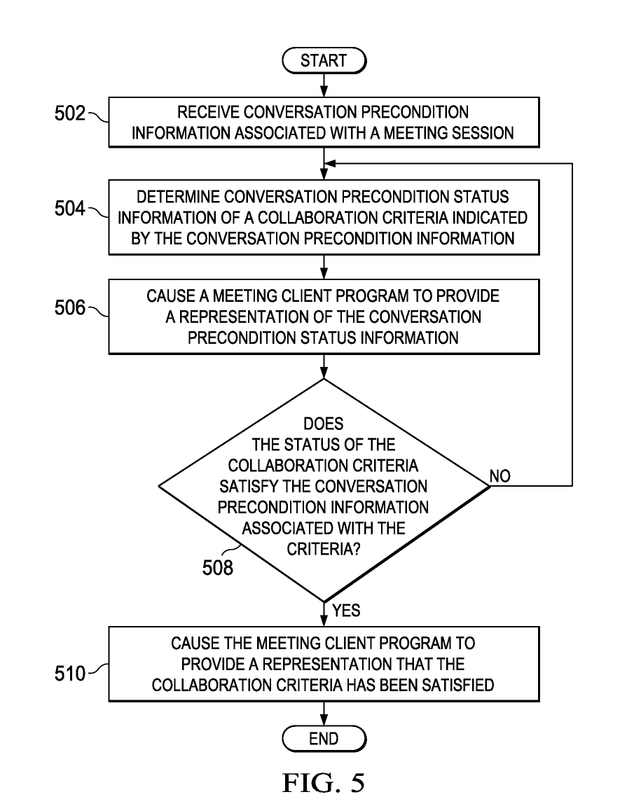

FIG. 5 is a flow diagram illustrating activities associated with managing a conversation according to at least one example embodiment. In at least one example embodiment, there is a set of operations that corresponds the activities of FIG. 5. An apparatus, for example MCS/MCC 44 of FIG. 1 and FIG. 9, or a portion thereof, may utilize the set of operations. The apparatus may comprise means, including, for example processor 84f of FIG. 9, for performing such operations. In an example embodiment, an apparatus, for example MCS/MCC 44 of FIG. 1 and FIG. 9, is transformed by having memory, for example memory element 86f of FIG. 9, comprising computer code configured to, working with a processor, for example processor 84f of FIG. 9, cause the apparatus to perform set of operations of FIG. 5.

At block 502, the apparatus receives conversation precondition information associated with a meeting session similar as described regarding block 402 of FIG. 4. At block 504, the apparatus determines conversation precondition status information of at least one collaboration criteria indicated by the conversation precondition information similar as described regarding block 404 of FIG. 4. At block 506, the apparatus causes a meeting client program to provide a representation of the conversation precondition status information similar as described regarding block 406 of FIG. 4. At block 508, the apparatus determines whether the status of the collaboration criteria satisfies the conversation precondition information associated with the at least one criteria.

In at least one example embodiment, the apparatus determines that the collaboration criteria is satisfied if all parameters associated with the collaboration criteria correlate to the meeting session attributes. If, at block 508, the apparatus determines that the status of the collaboration criteria satisfies the conversation precondition information associated with the at least one criteria, flow proceeds to block 510. Otherwise, flow proceeds to block 504. At block 510, the apparatus causes the meeting client program to provide a representation indicating that the at least one collaboration criteria indicated by the conversation precondition information has been satisfied, similar as described regarding FIGS. 2A-2C. In at least one example embodiment, causing provision of the representation indicating that the at least one collaboration criteria indicated by the conversation precondition information has been satisfied may be caused by sending of conversation precondition status information, a notification that a collaboration criteria has been satisfied, and/or the like, to a meeting client program.

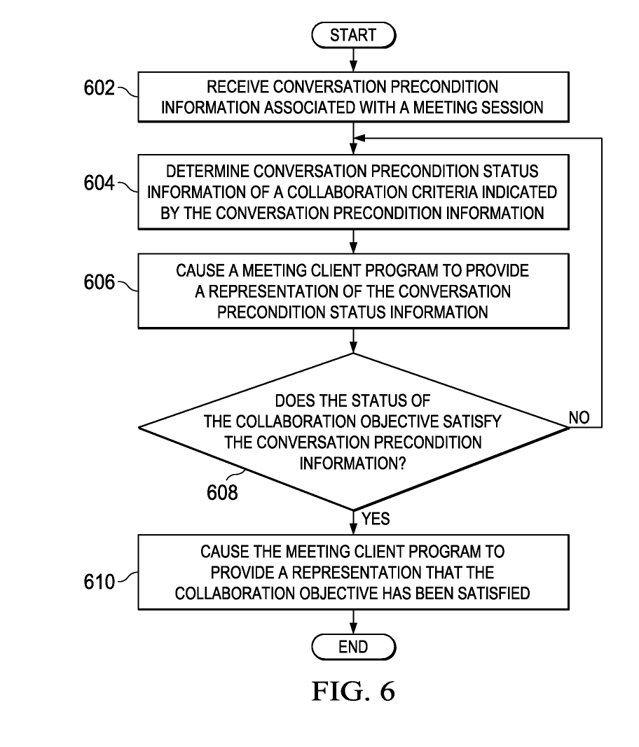

FIG. 6 is a flow diagram illustrating activities associated with managing a conversation according to at least one example embodiment. In at least one example embodiment, there is a set of operations that corresponds the activities of FIG. 6. An apparatus, for example MCS/MCC 44 of FIG. 1 and FIG. 9, or a portion thereof, may utilize the set of operations. The apparatus may comprise means, including, for example processor 84f of FIG. 9, for performing such operations. In an example embodiment, an apparatus, for example MCS/MCC 44 of FIG. 1 and FIG. 9, is transformed by having memory, for example memory element 86f of FIG. 9, comprising computer code configured to, working with a processor, for example processor 84f of FIG. 9, cause the apparatus to perform set of operations of FIG. 6.

At block 602, the apparatus receives conversation precondition information associated with a meeting session similar as described regarding block 402 of FIG. 4. At block 604, the apparatus determines conversation precondition status information of at least one collaboration criteria indicated by the conversation precondition information similar as described regarding block 404 of FIG. 4. At block 606, the apparatus causes a meeting client program to provide a representation of the conversation precondition status information similar as described regarding block 406 of FIG. 4. At block 608, the apparatus determines whether status of a collaboration objective satisfies the conversation precondition information. In at least one example embodiment, the apparatus determines that the collaboration objective is satisfied if all parameters associated with the collaboration criteria correlate to the meeting session attributes such that the interrelationships between the collaboration criteria are met. If, at block 608, the apparatus determines that the status of the collaboration objective satisfies the conversation precondition information, flow proceeds to block 610. Otherwise, flow proceeds to block 604.

At block 610, the apparatus causes the meeting client program to provide a representation indicating that the at least one collaboration objective indicated by the conversation precondition information has been satisfied, similar as described regarding FIGS. 2A-2C. In at least one example embodiment, causing provision of the representation indicating that the at least one collaboration objective indicated by the conversation precondition information has been satisfied may be caused by sending of conversation precondition status information, a notification that a collaboration objective has been satisfied, and/or the like, to a meeting client program.

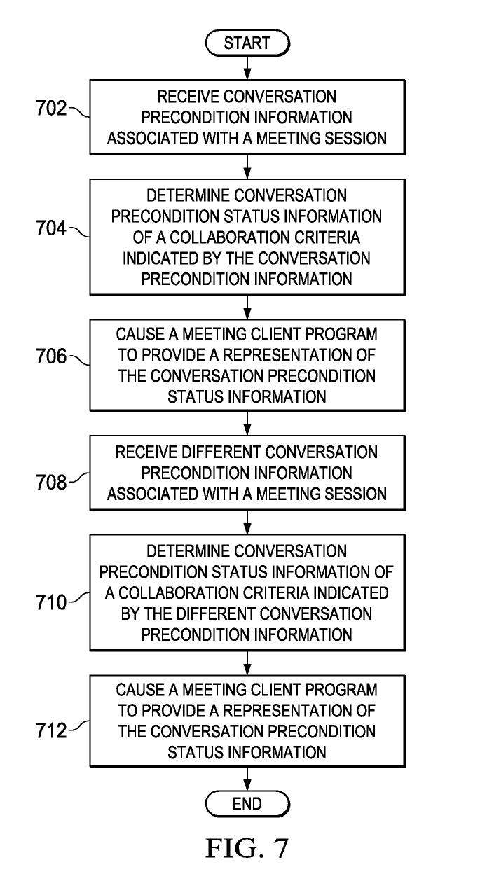

FIG. 7 is a flow diagram illustrating activities associated with managing a conversation according to at least one example embodiment. In at least one example embodiment, there is a set of operations that corresponds the activities of FIG. 7. An apparatus, for example MCS/MCC 44 of FIG. 1 and FIG. 9, or a portion thereof, may utilize the set of operations. The apparatus may comprise means, including, for example processor 84f of FIG. 9, for performing such operations. In an example embodiment, an apparatus, for example MCS/MCC 44 of FIG. 1 and FIG. 9, is transformed by having memory, for example memory element 86f of FIG. 9, comprising computer code configured to, working with a processor, for example processor 84f of FIG. 9, cause the apparatus to perform set of operations of FIG. 7.

At block 702, the apparatus receives conversation precondition information associated with a meeting session similar as described regarding block 402 of FIG. 4. At block 704, the apparatus determines conversation precondition status information of at least one collaboration criteria indicated by the conversation precondition information similar as described regarding block 404 of FIG. 4. At block 706, the apparatus causes a meeting client program to provide a representation of the conversation precondition status information similar as described regarding block 406 of FIG. 4. At block 708, the apparatus the apparatus receives different conversation precondition information associated with a meeting session similar as described regarding FIGS. 2A-2C and block 402 of FIG. 4. At block 710, the apparatus determines conversation precondition status information of at least one collaboration criteria indicated by the different conversation precondition information similar as described regarding block 404 of FIG. 4. At block 712, the apparatus causes a meeting client program to provide a representation of the conversation precondition status information similar as described regarding block 406 of FIG. 4.

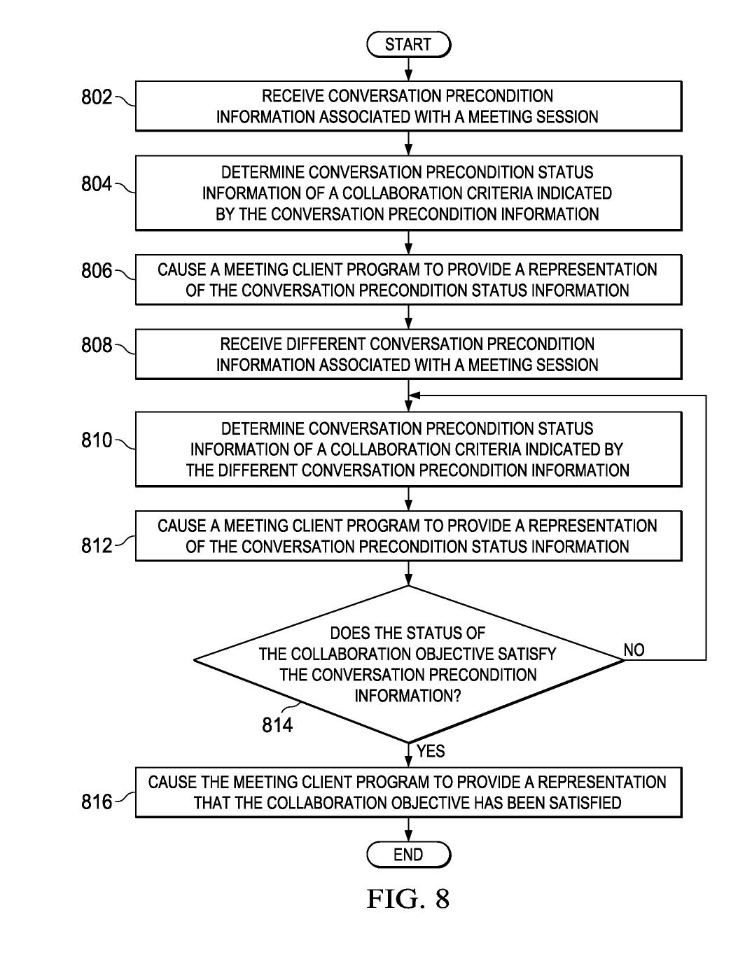

FIG. 8 is a flow diagram illustrating activities associated with managing a conversation according to at least one example embodiment. In at least one example embodiment, there is a set of operations that corresponds the activities of FIG. 8. An apparatus, for example MCS/MCC 44 of FIG. 1 and FIG. 9, or a portion thereof, may utilize the set of operations. The apparatus may comprise means, including, for example processor 84f of FIG. 9, for performing such operations. In an example embodiment, an apparatus, for example MCS/MCC 44 of FIG. 1 and FIG. 9, is transformed by having memory, for example memory element 86f of FIG. 9, comprising computer code configured to, working with a processor, for example processor 84f of FIG. 9, cause the apparatus to perform set of operations of FIG. 8.

At block 802, the apparatus receives conversation precondition information associated with a meeting session similar as described regarding block 402 of FIG. 4. At block 804, the apparatus determines conversation precondition status information of at least one collaboration criteria indicated by the conversation precondition information similar as described regarding block 404 of FIG. 4. At block 806, the apparatus causes a meeting client program to provide a representation of the conversation precondition status information similar as described regarding block 406 of FIG. 4. At block 808, the apparatus the apparatus receives different conversation precondition information associated with a meeting session similar as described regarding block 708 of FIG. 7.

At block 810, the apparatus determines conversation precondition status information of at least one collaboration criteria indicated by the different conversation precondition information similar as described regarding block 710 of FIG. 7. At block 812, the apparatus causes a meeting client program to provide a representation of the conversation precondition status information similar as described regarding block 712 of FIG. 7. At block 814, the apparatus determines whether status of a collaboration objective satisfies the different conversation precondition information similar as described regarding block 608 of FIG. 6. If, at block 814, the apparatus determines that the status of the collaboration objective satisfies the different conversation precondition information, flow proceeds to block 816. Otherwise, flow proceeds to block 810. At block 816, the apparatus causes the meeting client program to provide a representation indicating that the at least one collaboration objective indicated by the different conversation precondition information has been satisfied, similar as described regarding block 610 of FIG. 6.

FIG. 9 is a simplified schematic diagram illustrating possible details related to an example infrastructure of a communication system 10 in accordance with at least one example embodiment. Each of endpoints 12a-e are provisioned with a respective conversation flow module 82a-e, a respective processor 84a-e, a respective memory element 86a-e, a respective WebEx module 90a-e, a respective Meeting Place module 92a-e, and a respective network interface 88a-e, which includes a respective receiving module and a respective transmitting module for exchanging data (e.g., for exchanging packets in a network environment). FIG. 9 illustrates an example implementation of MCSs/MCC 44 that is similarly provisioned with a conversation flow module 82f, a processor 84f, and a memory element 86f.

In at least one example embodiment, each endpoint 12a-e and/or MCSs/MCC 44 includes software (e.g., as part of conversation flow modules 82a-f) to achieve or to support managing a conversation, as outlined herein in this document. In other embodiments, this feature may be provided externally to any of the aforementioned elements, or included in some other network element to achieve this functionality. Alternatively, several elements may include software (or reciprocating software) that may coordinate in order to achieve the operations, as outlined herein. In still other embodiments, any of the devices of the FIGURES may include any suitable algorithms, hardware, software, components, modules, interfaces, or objects that facilitate in managing a conversation.

It is imperative to note that FIG. 9 is indicative of just one, of the multitude, of example implementations of communication system 10. Any of the modules or elements within endpoints 12a-e and/or MCSs/MCC 44 may readily be replaced, substituted, or eliminated based on particular needs. Furthermore, although described with reference to particular scenarios, where a given module (e.g., WebEx module 90a-e, Meeting Place module 92a-e, conversation flow module 82a-e, etc.) is provided within endpoints 12a-e or MCSs/MCC 44, any one or more of these elements may be provided externally, or consolidated and/or combined in any suitable fashion. In certain instances, certain elements may be provided in a single proprietary module, device, unit, etc. in order to achieve the teachings of the present disclosure.

Endpoints 12a-e are representative of any type of client or user wishing to participate in a meeting session in communication system 10 (e.g., or in any other online platform). Furthermore, endpoints 12a-e may be associated with individuals, clients, customers, or end users wishing to participate in a meeting session in communication system 10 via some network. The term ‘endpoint’ is inclusive of devices used to initiate a communication, such as a computer, a personal digital assistant (PDA), a laptop or electronic notebook, a cellular telephone of any kind, an iPhone™, an IP phone, a Blackberry, a Google Droid™, an iPad™, a tablet, an Ultrabook™, a Microsoft Surface™, or any other device, component, element, or object capable of initiating voice, audio, video, media, or data exchanges within communication system 10. Endpoints 12a-e may also be inclusive of a suitable interface to the human user, such as a microphone, a display, or a keyboard or other terminal equipment. Endpoints 12a-e may also be any device that seeks to initiate a communication on behalf of another entity or element, such as a program, a proprietary conferencing device, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another.

MCSs/MCC 44 and web servers 32 are network elements that manage (or that cooperate with each other in order to manage) aspects of a meeting session. As used herein in this Specification, the term ‘network element’ is meant to encompass any type of servers (e.g., a video server, a web server, etc.), routers, switches, gateways, bridges, loadbalancers, firewalls, inline service nodes, proxies, network appliances, processors, modules, or any other suitable device, component, element, or object operable to exchange information in a network environment. This network element may include any suitable hardware, software, components, modules, interfaces, or objects that facilitate the operations thereof. This may be inclusive of appropriate algorithms and communication protocols that allow for the effective exchange (reception and/or transmission) of data or information. In one particular example, MCSs/MCC 44 and web servers 32 are servers that may interact with each other via the networks of FIG. 1.

Intranet 20, PSTN 22, and Internet 24 represent a series of points or nodes of interconnected communication paths for receiving and transmitting packets of information that propagate through communication system 10. These networks may offer connectivity to any of the devices or endpoints of FIG. 1. Moreover, Intranet 20, PSTN 22, and Internet 24 offer a communicative interface between sites (and/or participants, rooms, etc.) and may be any local area network (LAN), wireless LAN (WLAN), metropolitan area network (MAN), wide area network (WAN), extranet, Intranet, virtual private network (VPN), virtual LAN (VLAN), or any other appropriate architecture or system that facilitates communications in a network environment.

Intranet 20, PSTN 22, and Internet 24 may support a transmission control protocol (TCP)/IP, or a user datagram protocol (UDP)/IP in particular embodiments of the present disclosure; however, Intranet 20, PSTN 22, and Internet 24 may alternatively implement any other suitable communication protocol for transmitting and receiving data packets within communication system 10. Note also that Intranet 20, PSTN 22, and Internet 24 may accommodate any number of ancillary activities, which may accompany a meeting session. This network connectivity may facilitate all informational exchanges (e.g., notes, virtual whiteboards, PowerPoint presentations, e-mailing, word-processing applications, etc.). Along similar reasoning, Intranet 20, PSTN 22, and Internet 24 may foster all such communications and, further, be replaced by any suitable network components for facilitating the propagation of data between participants in a conferencing session.

It should also be noted that endpoints 12a-e and MCSs/MCC 44 may share (or coordinate) certain processing operations. Using a similar rationale, their respective memory elements may store, maintain, and/or update data in any number of possible manners. Additionally, any of the illustrated memory elements or processors may be removed, or otherwise consolidated such that a single processor and a single memory location is responsible for certain activities associated with managing a conversation. In a general sense, the arrangement depicted in FIG. 7 may be more logical in its representations, whereas a physical architecture may include various permutations/combinations/hybrids of these elements.

Note that in certain example embodiments, the conversation management functions outlined herein may be implemented by logic encoded in one or more tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory element (as shown in FIG. 7) may store data used for the operations described herein. This includes the memory element being able to store software, logic, code, or processor instructions that may be executed to carry out the activities described in this Specification. A processor may execute any type of instructions associated with the data to achieve the operations detailed herein in this Specification. In one example, the processor (as shown in FIG. 7) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, conversation flow modules 82a-f include software in order to achieve the conversation management functions outlined herein. These activities may be facilitated by MCSs/MCC 44 and/or the various endpoints 12a-f. MCSs/MCC 44 and/or endpoints 12a-f may include memory elements for storing information to be used in managing a conversation, as outlined herein. Additionally, MCSs/MCC 44 and/or endpoints 12a-f may include a processor that may execute software or an algorithm to perform management of a conversation, as discussed in this Specification. These devices may further keep information in any suitable memory element (random access memory (RAM), ROM, EPROM, EEPROM, ASIC, etc.), software, hardware, or in any other suitable component, device, element, or object where appropriate and based on particular needs. Any possible memory items (e.g., database, table, cache, etc.) should be construed as being encompassed within the broad term ‘memory element.’ Similarly, any of the potential processing elements, modules, and machines described in this Specification should be construed as being encompassed within the broad term ‘processor.’

Note that with the examples provided herein, interaction may be described in terms of two or three elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and may accommodate a large number of rooms and sites, as well as more complicated/sophisticated arrangements and configurations. Accordingly, the examples provided herein should not limit the scope or inhibit the broad teachings of communication system 10 as potentially applied to a myriad of other architectures. Additionally, although described with reference to particular scenarios where MCSs/MCC 44 resides in a particular physical location, MCSs/MCC 44 may reside in any location, provided it has some connectivity to a suitable network.

It is also important to note that the steps discussed with reference to FIGS. 1-9 illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular embodiments, it should be understood that various other changes, substitutions, and alterations may be made hereto without departing from the spirit and scope of the present disclosure. For example, although the present disclosure has been described as operating in WebEx and Meeting Place conferencing environments or arrangements, the present disclosure may be used in any online environment that could benefit from such technology. For example, in certain instances, computers that are coupled to each other in some fashion may utilize the teachings of the present disclosure (e.g., even though participants would be in a face-to-face arrangement). Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A method, comprising:
receiving conversation precondition information associated with a meeting session in a network environment;
determining, after a beginning of the meeting session, conversation precondition status information of at least one collaboration criteria indicated by the conversation precondition information; and
causing a meeting client program to provide a representation of the conversation precondition status information.

2. The method of claim 1, further comprising:
determining that a status of the at least one criteria indicated by the conversation precondition information satisfies the conversation precondition information associated with the at least one criteria; and
causing the meeting client program to provide a representation indicating that the at least one criteria indicated by the conversation precondition information has been satisfied.

3. The method of claim 2, wherein causing a meeting client program to provide a representation indicating that the at least one criteria indicated by the conversation precondition information has been satisfied comprises sending a notification indicating that at least one criteria indicated by the conversation precondition information has been satisfied.

4. The method of claim 2, further comprising:
determining that status of a collaboration objective indicated by the conversation precondition information satisfies the conversation precondition information; and
causing the meeting client program to provide a representation indicating that the collaboration objective indicated by the conversation precondition information has been satisfied.

5. The method of claim 1, wherein the conversation precondition information is received from a meeting participant.

6. The method of claim 1, wherein the conversation precondition information is received from a repository.

7. The method of claim 1, further comprising:
causing a meeting client program to provide a representation of the conversation precondition information before the beginning of the meeting session.

8. The method of claim 1, further comprising:
receiving different conversation precondition information associated with the meeting session after the beginning of the meeting session;
determining conversation precondition status information of at least one collaboration criteria indicated by the different conversation precondition information; and
causing the meeting client program to provide a representation of the conversation precondition status information.

9. An apparatus comprising at least one processor and at least one memory, the at least one memory including computer program instructions that, when executed by the at least one processor, cause the apparatus to:
receive conversation precondition information associated with a meeting session in a network environment;
determine, after a beginning of the meeting session, conversation precondition status information of at least one collaboration criteria indicated by the conversation precondition information; and
cause a meeting client program to provide a representation of the conversation precondition status information.

10. The apparatus of claim 9, wherein the memory further includes computer program instructions that, when executed by the at least one processor, cause the apparatus to:
determine that a status of the at least one criteria indicated by the conversation precondition information satisfies the conversation precondition information associated with the at least one criteria; and
cause the meeting client program to provide a representation indicating that the at least one criteria indicated by the conversation precondition information has been satisfied.

11. The apparatus of claim 10, wherein causing a meeting client program to provide a representation indicating that the at least one criteria indicated by the conversation precondition information has been satisfied comprises sending a notification indicating that at least one criteria indicated by the conversation precondition information has been satisfied.

12. The apparatus of claim 10, wherein the memory further includes computer program instructions that, when executed by the at least one processor, cause the apparatus to:
determine that status of a collaboration objective indicated by the conversation precondition information satisfies the conversation precondition information; and
cause the meeting client program to provide a representation indicating that the collaboration objective indicated by the conversation precondition information has been satisfied.

13. The apparatus of claim 9, wherein the conversation precondition information is received from a meeting participant.

14. The apparatus of claim 9, wherein the conversation precondition information is received from a repository.

15. The apparatus of claim 9, wherein the memory further includes computer program instructions that, when executed by the at least one processor, cause the apparatus to cause a meeting client program to provide a representation of the conversation precondition information before the beginning of the meeting session.

16. The apparatus of claim 9, wherein the memory further includes computer program instructions that, when executed by the at least one processor, cause the apparatus to:
receive different conversation precondition information associated with the meeting session after the beginning of the meeting session;
determine conversation precondition status information of at least one collaboration criteria indicated by the different conversation precondition information; and
cause the meeting client program to provide a representation of the conversation precondition status information.

17. The apparatus of claim 9, wherein the apparatus is a media conference server.

18. A non-transitory computer readable medium comprising instructions that, when executed, cause an apparatus to:
receive conversation precondition information associated with a meeting session in a network environment;
determine, after a beginning of the meeting session, conversation precondition status information of at least one collaboration criteria indicated by the conversation precondition information; and
cause a meeting client program to provide a representation of the conversation precondition status information.

19. The medium of claim 18, wherein the instructions further cause the apparatus to:
determine that a status of the at least one criteria indicated by the conversation precondition information satisfies the conversation precondition information associated with the at least one criteria; and
cause the meeting client program to provide a representation indicating that the at least one criteria indicated by the conversation precondition information has been satisfied.

20. The medium of claim 19, wherein causing a meeting client program to provide a representation indicating that the at least one criteria indicated by the conversation precondition information has been satisfied comprises sending a notification indicating that at least one criteria indicated by the conversation precondition information has been satisfied.

21. The medium of claim 19, wherein the instructions further cause the apparatus to:
determine that status of a collaboration objective indicated by the conversation precondition information satisfies the conversation precondition information; and
cause the meeting client program to provide a representation indicating that the collaboration objective indicated by the conversation precondition information has been satisfied.

22. The medium of claim 18, wherein the conversation precondition information is received from a meeting participant.

23. The medium of claim 18, wherein the conversation precondition information is received from a repository.

24. The medium of claim 18, wherein the instructions further cause the apparatus to cause a meeting client program to provide a representation of the conversation precondition information before the beginning of the meeting session.

25. The medium of claim 18, wherein the instructions further cause the apparatus to:
receive different conversation precondition information associated with the meeting session after the beginning of the meeting session;
determine conversation precondition status information of at least one collaboration criteria indicated by the different conversation precondition information; and
cause the meeting client program to provide a representation of the conversation precondition status information.
